(19) United States
(12) Patent Application Publication
(10) Pub. No.: US 2007/0119547 A1
(43) Pub. Date: May 31, 2007

(54) Cordless window blind structure

(75) Inventor: Wen Ying Liang, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/344,233

(22) Filed: Feb. 1, 2006

(30) Foreign Application Priority Data
Nov. 30, 2005 (TW) 094220796

(51) Int. Cl. E06B 9/30

(52) U.S. Cl. 160/170

(57) ABSTRACT

A cordless window blind structure comprises a head rail having a fixed seat and a cord-winding control unit with an operating cord attached thereto mounted in both ends, and a movable seat accommodated to situate there-between wherein the operating cord is attached to the movable seat at one end, and retrieving cords are guided through the bottom surface of the head rail. The retrieving cords are respectively led through a blind body to fix to a bottom rail at the bottommost ends, while the other ends thereof are synchronically wound onto the fixed seat and the movable seat before firmly attached to the fixed seat. Therefore, the bottom rail is pushed or pulled by hands to loosen or tighten the retrieving cords and actuate the movement of the operating cord therewith to form a state of counterbalance there-between for easy adjustment of the blind body into a desirable position.

### BACKGROUND OF THE INVENTION

The present invention relates to a cordless window blind structure, comprising a head rail having a fixed seat and a cord-winding control unit with an operating cord attached thereto respectively mounted at both ends, and a movable seat situated there-between wherein the operating cord is attached to the movable seat at one end, and retrieving cords are wound onto the fixed seat and the movable seat thereof, permitting the operating cord and the retrieving cords to reciprocally associate with each other in linking operation so that a bottom rail is simply pushed or pulled by hands to loosen or tighten the retrieving cords and actuate the movement of the operating cord therewith to form a state of counterbalance there-between for easy adjustment of the blind body into a desirable position thereby.

A conventional window blind structure is usually made up of a blind body, an operating drive assembly, and a pull cord. In operation, the pull cord is drawn by force exerted by hands of a user, and the small frictional surface of the pull cord tends to rub against the hands exerting force thereon and, thus, hurt the area of hands contacting with it. Besides, in case of an excessive down-pulling force exerted onto the pull cord or a sudden release at great speed, the blind body cannot be accurately positioned in a desirable position and the adjustment process must be repeated over again, which is quite inconvenient in operation.

### SUMMARY OF THE PRESENT INVENTION

It is, therefore, the primary purpose of the present invention to provide a cordless window blind structure wherein pushing or pulling force is exerted by hands of a user to cooperatively work with the elasticity generated by torsion springs mounted to a cord-winding control unit, permitting the user to freely adjust a blind body into a desirable position without getting hurt on the hands as shown in the conventional pulling cord above to achieve the best application state thereby.

It is, therefore, the second purpose of the present invention to provide a cordless window blind structure wherein pushing or pulling force is exerted by the hands to cooperatively work with the elasticity generated by the torsion springs of the cord-winding control unit, permitting the blind body to precisely locate in a desirable expanded or collected position as pulled or pushed by the hands of the user in operation without the inconvenience of repeated readjustment caused by the above conventional pull cord to achieve an accuracy and simplicity in operation as well as in assembly thereof.

It is, therefore, the third purpose of the present invention to provide a cordless window blind structure wherein a movable seat and a fixed seat are respectively equipped with a dividing board to divide a set of upper and lower winding spaces thereon and a separating board to separate a set of upper and lower winding grooves thereon, permitting the retrieving cords to accurately wind onto a set of first and second gliding elements of the dividing board and a set of first, second, and third sliding elements of the separating board for separation and guiding purposes so that the blind body can be easily and smoothly expanded and collected without the retrieving cords being entangled and caught immovable in operation thereof.

### BRIEF DESCRIPTION OF THE DRAWINGS

FIG. 1 is an exploded perspective view of the present invention.

FIG. 2 is an enlarged perspective view of a fixed seat of the present invention.

FIG. 3 is an assembled cross sectional view of the present invention.

FIG. 4 is a diagram showing a blind body of the present invention operated to expand downward in application.

FIG. 5 is a diagram showing the blind body of the present invention operated to collect upwards in application.

FIG. 6 is another assembled cross sectional view of the present invention.

FIG. 7 is a third assembled cross sectional view of the present invention.

### DETAILED DESCRIPTION OF THE PREFERRED EMBODIMENTS

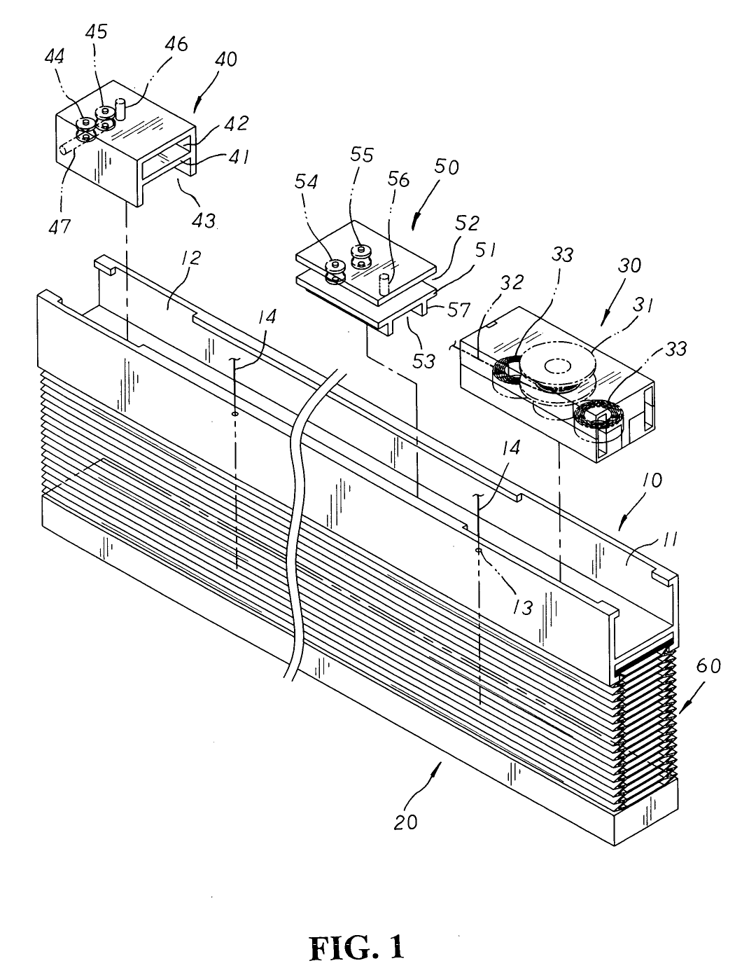

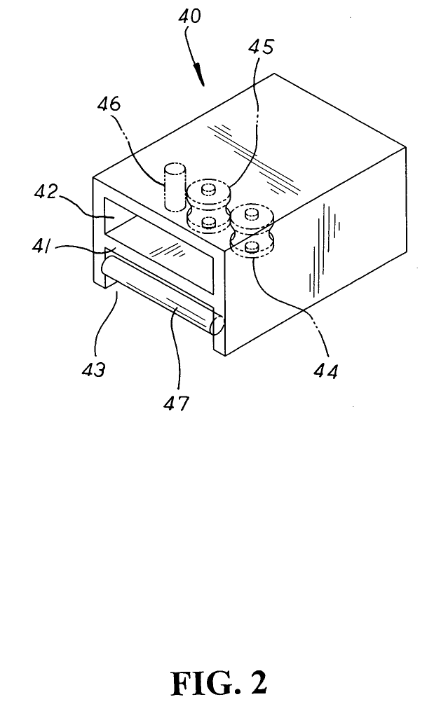

Please refer to FIG. 1 showing an exploded perspective view of the present invention. The present invention relates to a cordless window blind structure, comprising a head rail 10, a bottom rail 20, a cord-winding control unit 30, a fixed seat 40, a movable seat 50, and a blind body 60 wherein the head rail 10 has a set of first and second accommodating cavities 11, 12 indented at both ends thereon, and a plurality of cord-passages 13 disposed at the bottom surface thereon for the extension of retrieving cords 14 there-through respectively. Each retrieving cord 14 is guided to pass through the blind body 60 and attach to the bottom rail 20 at the bottommost end thereof. The cord-winding unit 30 has a rotary seat 31 mounted therein, and an operating cord is fixed to the rotary seat 31 at one end thereof. The lower end of the rotary seat 31 has a set of torsion springs 33 attached to both lateral sides thereon, permitting the torsion springs 33 actuated by the movement of the operating cord 32 and the clockwise or counterclockwise rotation of the rotary seat 31 to counter-wind or recoil and elastically position thereby. The fixed seat 40 (molded in an inverted U-shaped configuration) and the movable seat 50 are respectively equipped with a middle separating board 41 and a middle dividing board 51 to form a set of upper/lower winding grooves 42, 43, and a set of upper/lower winding spaces 52, 53 thereon. The upper winding groove and winding space 42, 52 have a set of first and second sliding elements 44, 45 with a rod-like fixing element 46, and a set of first and second gliding elements 54, 55 with a positioning element 56 extending at appropriate positions thereon respectively. The first and second sliding elements 44, 45 of the fixed seat 40 and the first and second gliding elements 54, 55 of the movable seat 50 are symmetrically arranged to align side by side in spacing respectively. And the fixing element 45 of the fixed seat 40 is located at one side of the second sliding element 45 thereof, while the positioning element 56 of the movable seat 50 is situated at one side of the dividing board 51 symmetrically opposite to the first and second gliding elements 54, 55 thereof. The fixed seat 40 is also provided with a third sliding element 47 at the lower winding groove 43 thereon, and the movable seat 50 has support legs 57 extending at the lower winding space 53 thereon wherein the third sliding element 47 are disposed precisely protruding at one side of the separating board 41 as shown in FIG. 2. The retrieving cords 14 and the operating cord 32 can be made of straps or ropes, etc.

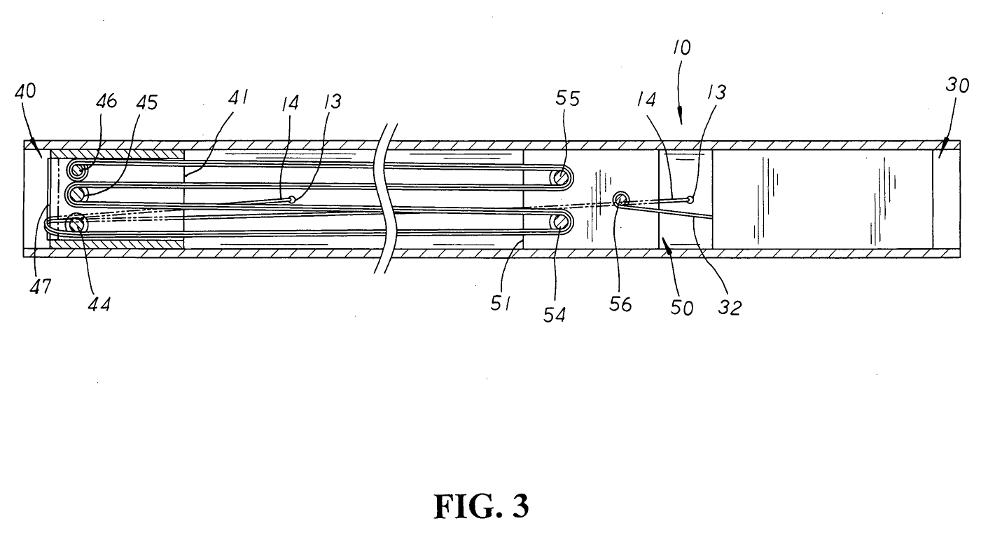

Please refer to FIG. 3 showing an assembled cross sectional view of the present invention. The movable seat 50 is guided from one side of the first accommodating cavity 11 to slide into the head rail 10 in restricting location therein. Then, the cord-winding control unit 30 and the fixed seat 40 are respectively mounted into the first and the second accommodating cavities 11, 12 and firmly positioned therein, permitting the movable seat 50 to precisely situate between the cord-winding unit 30 and the fixed seat 40 thereby. The retrieving cords 14 are respectively guided through the bottom surface of the head rail 10 to run along the lower winding space 53 of the movable seat 50 and the lower winding groove 43 of the fixed seat 40 respectively before synchronically led to wind around the third sliding element 47 and further extend from the separating board 41 of the upper winding groove 42 to the dividing board 51 of the upper winding space 52 thereof. Then, the retrieving cords 14 are guided in consecutive S-shaped manner to wind onto the first gliding element 54, the second sliding element 45, and then the second gliding element 55 in a sequence before each retrieving cord 14 is synchronically led to attach to the fixing element 46 thereon. And, the other end of the operating cord 32 attached to the cord-winding control unit 30 at one end thereof is fixed to the positioning element 56 of the movable seat 50, permitting the operating cord 32 and the retrieving cords 14 to reciprocally associate with each other in linking operation so as to actuate the movable seat 50 thereby, completing the assembly of the present invention.

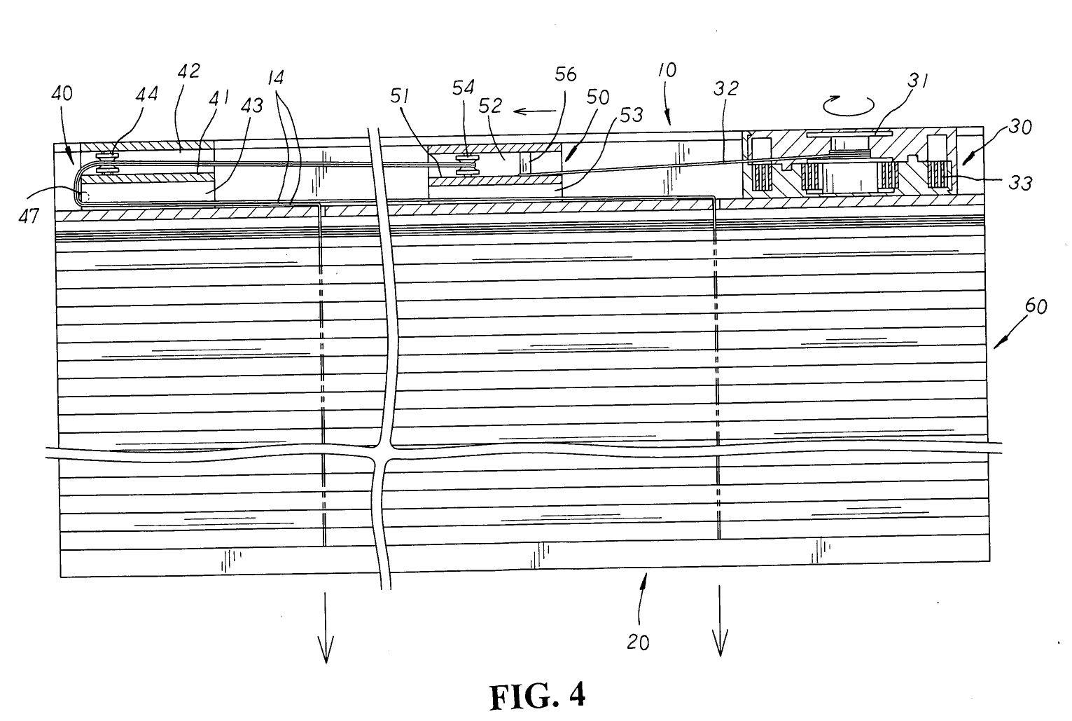

In application, when the blind body 60 as shown in FIG. 4 is to be expanded downwards, the bottom rail 20 is pulled downwards by hands. Then, the retrieving cords 14 drawn by the bottom rail 20 at the bottommost ends will run along the first and second sliding and gliding elements 44, 45, 54, 55 of the fixed seat 40 and the movable seat 50 respectively and stretch along the separating and dividing boards 41, 51 and the third sliding element 47 thereof to lower downwards thereby. The movable seat 50 pulled by the lowered retrieving cords 14 will slide towards the fixed seat 40 accordingly, and the operating cord 32 drawn by the movable seat 50 therewith will actuate the rotary seat 31 of the cord-winding control unit 30 to revolve in clockwise rotation. Meanwhile, the two torsion springs 33 juxtaposed and connected to both lateral sides of the rotary seat 31 to augment the elasticity thereby will be affected by the pulling forcing to revolve counterclockwise in an S shape rotation with a constant torque naturally occurred to counter wind onto the rotary seat 31 till coiled tight thereon. Furthermore, the constant torque occurred works in a linear operation and the torque will not be altered due to the increase of the coils counter wound thereon, reinforcing the strengthen of the blind body 60 affected by the pulling force to achieve efficient suspension thereby.

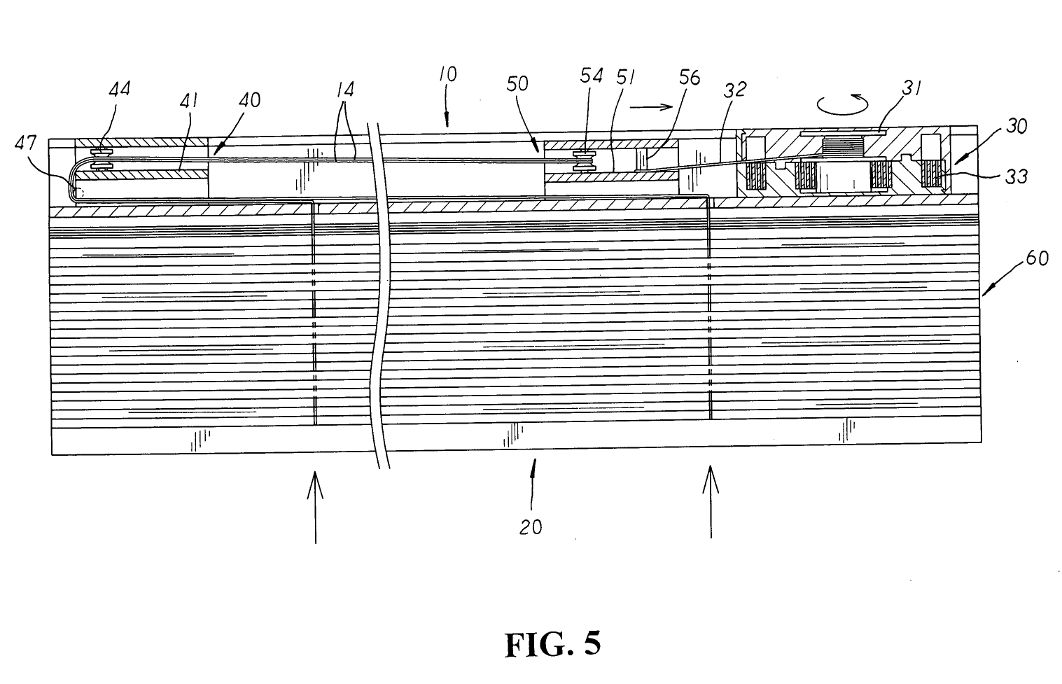

When the blind body 60 as shown in FIG. 5 is to be collected upwards, the bottom rail 20 is pushed upwards by hands, and the counter-wound torsion springs 33 will be released to naturally recoil backwards, permitting the rotary seat 31 to revolve in counterclockwise rotation with a constant torque occurred at the same time. Then, the movable seat 50 will be freed from the pulling force of the loosened retrieving cords 14, and actuated by the pulling force of the withdrawing operating cord 32 to slide towards the cord-winding control unit 30. Meanwhile, the retrieving cords 14 are actuated by the sliding movement of the movable seat 50 to run around the first and the second gliding elements 54, 55 and retrieve upwards so as to collect the blind body 60 thereby. Therefore, via the pushing and pulling forces exerted by the hands to cooperatively work with the cord-winding control unit 30 with constant torque occurred in linking operation thereof, the present invention can refrain the hands from getting hurt by the above-mentioned pull cord so that a user can freely adjust the blind body 60 into a desirable position to achieve the best application state thereby. In addition, the movable seat 50 and the fixed seat 40 are respectively equipped with the dividing board 51 with the upper and lower winding spaces 52, 53 and the separating board 41 with the upper and lower winding grooves 42, 43 so that the retrieving cords 14 can be accurately and sequentially wound onto the first and second gliding elements 54, 55 and the first, second, and third sliding elements 44, 45, 47 thereof respectively to achieve separation and guiding purposes thereby. Thus, the blind body 60 can be easily and smoothly expanded and collected without the retrieving cords 14 being entangled or caught immovable in operation.

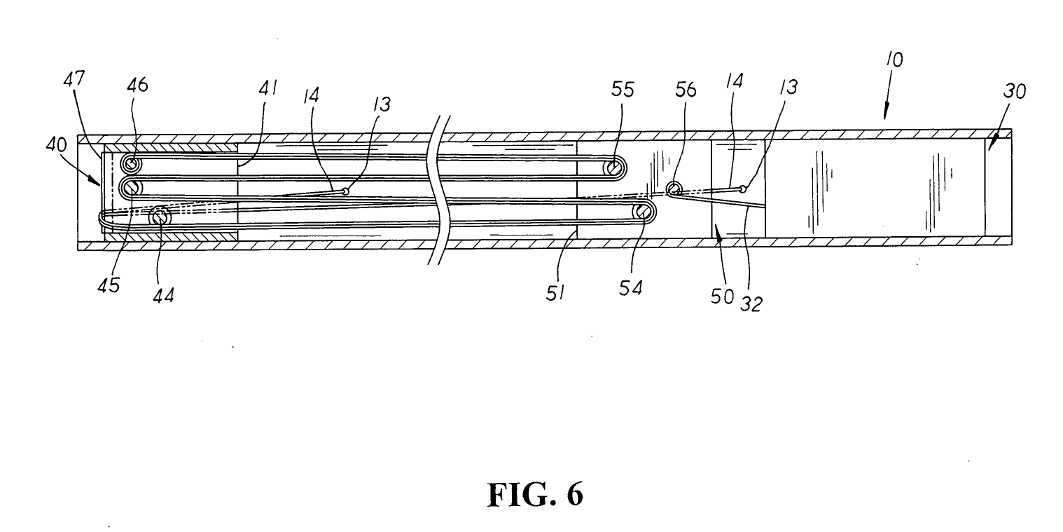

Please refer to FIG. 6 showing another assembled cross sectional view of the present invention. The first gliding element 54 of the movable seat 50 and the first sliding element 44 of the fixed seat 40 can be alternatively arranged to situate at the rear side of the second gliding element 55 and the second sliding element 45 in spacing respectively.

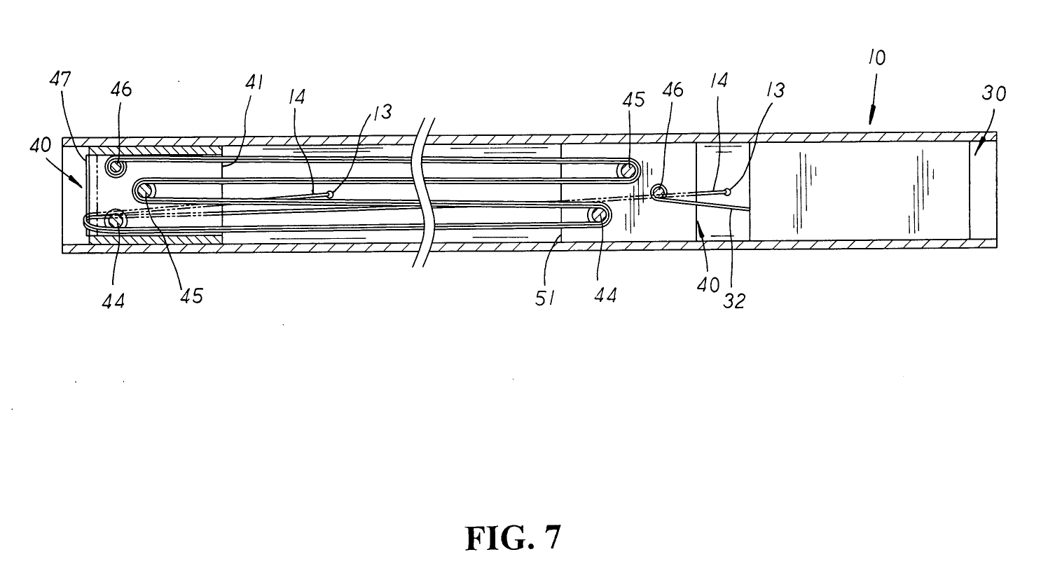

Please refer to FIG. 7 showing a third assembled cross sectional view of the present invention. The second gliding element 55 of the movable seat 50 and the second sliding element 45 of the fixed seat 40 can also be alternatively arranged to situate at the rear side of the first gliding element 54 and the first sliding element 44 in spacing respectively.

What is claimed is:

1. A cordless window blind structure, comprising a head rail having a fixed seat and a cord-winding control unit with an operating cord attached thereto respectively mounted at both ends therein, and a movable seat situated between the fixed seat and the cord-winding control unit thereof wherein the other end of the operating cord is attached to the movable seat thereof, and a plurality of retrieving cords are guided to extend through the bottom surface of the head rail thereof; the retrieving cords are respectively led through a blind body to fix to a bottom rail at the bottommost ends thereof, while the other ends thereof are synchronically wound onto the fixed seat and the movable seat before firmly attached to the fixed seat thereof; therefore, the operating cord of the cord-winding control unit and the retrieving cords wound onto the movable seat and the fixed seat thereof are reciprocally associated with each other in linking operation so that, in operation, the bottom rail is simply pushed or pulled by hands to loosen or tighten the retrieving cords wound onto the movable seat, and actuate the movement of the operating cord therewith to form a state of counterbalance there-between, permitting a user to easily and smoothly adjust the blind body into a desirable collected or expanded position thereby.

2. The cordless window blind structure as claimed in claim 1 wherein the head rail has a set of first and second accommodating cavity indented at both ends thereon for the mounting of the fixed seat and the cord-winding control unit in abutting location therein respectively.

3. The cordless window blind structure as claimed in claim 1 wherein the head rail has a plurality of cord-passages disposed at the bottom surface thereon for the extension of the retrieving cords there-through respectively.

4. The cordless window blind structure as claimed in claim 1 wherein the cord-winding control unit has a rotary seat mounted therein for one end of the operating cord to attach thereto, and the lower end of the rotary seat has a set of torsion springs connected to both lateral sides thereon, permitting the torsion springs to counter-wind or recoil and elastically position according to the actuation of the operating cord and the clockwise/counterclockwise rotation of the rotary seat thereby.

5. The cordless window blind structure as claimed in claim 1 wherein the fixed seat thereof is made in an inverted U-shaped configuration.

6. The cordless window blind structure as claimed in claim 1 wherein the fixed seat and the movable seat are respectively equipped with a middle separating board and a middle dividing board to allow a set of upper and lower winding grooves and a set of upper and lower winding spaces formed thereon, and the upper winding groove of the fixed seat has a set of first and second sliding elements and a rod-like fixing element disposed at appropriate positions thereon, while the upper winding space of the movable seat has a set of first and second gliding elements and a rod-like positioning element disposed thereon.

7. The cordless window blind structure as claimed in claim 6 wherein the first and second sliding elements of the fixed seat and the first and second gliding elements of the movable seat are symmetrically arranged to align side by side in spacing respectively.

8. The cordless window blind structure as claimed in claim 6 wherein the fixing element of the fixed seat is situated at one side of the second sliding element thereof.

9. The cordless window blind structure as claimed in claim 6 wherein the positioning element of the movable seat is located at one side of the dividing board thereon symmetrically opposite to the first and second gliding elements in arrangement.

10. The cordless window blind structure as claimed in claim 6 wherein the fixed seat has a third sliding element disposed at the lower winding groove thereon, and the third sliding element are disposed precisely extending at one side of the separating board thereon.

11. The cordless window blind structure as claimed in claim 6 wherein the movable seat has support legs extending at the lower winding space thereon.

12. The cordless window blind structure as claimed in claim 6 wherein the first gliding element of the movable seat and the first sliding element of the fixed seat can be alternatively arranged to situate at the rear side of the second gliding element and the second sliding element in spacing respectively.

13. The cordless window blind structure as claimed in claim 6 wherein the second gliding element of the movable seat and the second sliding element of the fixed seat can also be alternatively arranged to situate at the rear side of the first gliding element and the first sliding element in spacing respectively.

14. The cordless window blind structure as claimed in claim 1 wherein the retrieving cords and the operating cord can be made of straps or ropes, etc.
